(19) United States
(12) Patent Application Publication
(10) Pub. No.: US 2022/0396692 A1
(43) Pub. Date: Dec. 15, 2022

(54) USE OF A POLYMER COMPOSITION, CRATE MANUFACTURED IN SUCH POLYMER COMPOSITION AND METHOD OF MANUFACTURING SUCH CRATE OR PALLET

(71) Applicant: Anheuser-Busch InBev S.A., Brussels (BE)

(72) Inventors: Daniel PEIRSMAN, Leuven (BE); Farida BENSADOUN, Leuven (BE)

(21) Appl. No.: 17/776,318

(22) PCT Filed: Nov. 13, 2020
(86) PCT No.: PCT/EP2020/082040

§ 371 Date: May 12, 2022

(30) Foreign Application Priority Data
Nov. 13, 2019 (BE) 2019/5788

(51) Int. Cl. C08L 23/12; C08L 23/06; C08L 23/16; C08L 9/06

(52) U.S. Cl. CPC C08L 23/12; C08L 23/06; C08L 23/16; C08L 9/06; C08L 2207/062; C08L 2205/02

(57) ABSTRACT

Use of a polymer composition comprising a thermoplastic resin and a rubber, wherein said polymer composition does not comprise ethylene vinyl acetate, for manufacturing crates or pallets.

### FIELD OF THE INVENTION

The present invention concerns crates or pallets suitable for holding and transporting containers, for example beverage bottles or cans and in particular beer bottles.

### BACKGROUND TO THE INVENTION

Crates and pallets for holding and transporting beer bottles exist in a wide variety of shapes and materials and have proven effective and efficient in packing and transporting beer bottles from a brewery to a point of sales and from a point of sales to a point of consumption and back to the brewery.

As crates (and pallets) are transported in various ways—in cargo from a brewery to a point of sales and typically piece by piece in trunks of cars, on bicycle racks, by hand, with various stop overs and often rather through rough handling, especially when the crate holds empty beer bottles, crates need to meet rather stringent requirements in terms of, amongst others, impact resistance, thermal resistance, tensile strength, resistance to stress cracking. Furthermore, provided the huge amounts of crates in use, the crates are preferably cheap in production, reusable and recyclable.

EP3135595, EP3015381 and EP2311741 disclose crates for holding bottles, the crates manufactured in a high density polyethylene by injection molding and/or foaming. US2004/0253402 discloses a crate manufactured in a transparent polycarbonate.

The present invention aims at providing alternative material formulations for crates, allowing manufacturing crates having thinner walls than existing polymeric crates or pallets while maintaining or even improving the strength of the crates; allowing manufacturing crates having increased sustainability in terms of both lifetime and recycling and with good and potentially improved properties of the crates or pallets in terms of impact resistance, thermal resistance, tensile strength and resistance to stress cracking, thereby reducing transport cost, production cost and environmental impact.

In terms of recycling, the present invention aims at polymer compositions that can be recycled by reproducing a crate or pallet according to the present invention from an existing crate and this for an increased number of recycling cycles in view of existing polymeric crates, respectively pallets.

### SUMMARY OF THE INVENTION

The present invention addresses the above goals by providing a polymer composition comprising a thermoplastic resin and a rubber, wherein said polymer composition does not comprise ethylene vinyl acetate, for manufacturing crates comprising an array of slots for holding containers therein or pallets.

The present invention also concerns a pallet or a crate comprising an array of slots for holding containers therein, said pallet or crate manufactured from a polymer composition comprising a thermoplastic resin and a rubber, characterized in that said polymer composition does not comprise ethylene vinyl acetate.

Further, the present invention is directed at a method of manufacturing a crate or pallet as identified above, comprising:
providing a polymer composition comprising a thermoplastic resin and a rubber, wherein said polymer composition does not comprise ethylene vinyl acetate;
injection molding a crate or pallet with said polymer composition or extruding a sheet of material from said polymer composition and thermoforming said sheet of material to obtain said crate or pallet.

### DETAILED SUMMARY OF THE INVENTION

The crate according to the present invention preferably comprises slots holding beverage bottles or cans, in particular beer bottles or cans. The pallet according to the present invention is defined as a structure comprising a load bearing surface and a number of supports configured to rest on a ground surface thereby maintaining the load bearing surface at a level above ground level.

Preferably the crate or pallet is manufactured from a polymer composition comprising a thermoplastic resin and a rubber, characterized in that said polymer composition does not comprise ethylene vinyl acetate.

The thermoplastic resin may be selected from a group comprising: polyolefin, polyester, polycarbonate, acrylonitrile-butadiene-styrene (ABS), polymethylmethacrylate (PMMA), polystyrene, polyvinylchloride, polyamide, polyurethane, melamine, polylactic acid and/or combinations thereof. Most preferably, the thermoplastic resin is a high-density polyethylene (HDPE), Polypropylene (PP) or a blend of HDPE with Polyethylene (PE) and/or Polypropylene (PP).

The rubber in the polymer composition is preferably selected from the group comprising: styrene-based rubber; polyolefin based elastomers (POE); nitrile-butadiene rubbers, acrylonitril-butadiene rubbers, chloroprene rubbers, polyisobutylene rubbers and butyl rubber and/or combinations thereof, in particular a styrene-butadiene-styrene copolymer or a rubber made of ethylene propylene diene monomers (EPDM).

The polymer composition preferably comprises less than 30 w % rubber, more preferably between 5 and 10 w % rubber.

Optionally, the polymer composition may comprise a filler material selected from the group comprising: talc, a siloxane, calcium carbonate, carbon black and/or combinations thereof. In case talc is used as filler, it is preferred that the polymer composition comprises less than 40 w % talc, preferably between 5 and 30 w % talc.

The polymer composition can comprise a lubricant in an amount of between 0.5 and 5 w %, a preferred lubricant is an ultra-high molecular weight siloxane.

The polymer composition may comprise maleic anhydride, preferably in an amount of between 0.01 and 0.05 w % maleic anhydride.

### DETAILED DESCRIPTION OF A PREFERRED EMBODIMENT

The present invention concerns a crate or pallet, in particular a polymeric pallet or a polymeric crate for transporting beverage containers such as bottles or cans. The crate can be designed in a plurality of shapes, yet traditional crates have four sidewalls and a bottom wall defining an inner cavity of the crate, and a plurality of compartment walls extending upright in view of the bottom wall of the crate and defining an array of slots each configured to hold one single container. In two opposed side walls slots may be provided that can serve as handles for carrying the crate, while in the bottom wall or at an outer edge of the bottom wall in the side walls, drain holes can be provided.

Optionally, an outer surface defined by the sidewalls of the crate can be provided with graphics or another type of decoration. Such decoration can be executed as a kind of embossing or local thickness variation in the side walls of the crate (eg in-mold labelling), as a printed coating (eg. screen printing) or as a coating adhered to the side walls or wrapped around the side walls.

The crate or pallet according to the present invention is a structural entity that has a load-bearing functionality sufficient to carry its own weight plus the weight of a number of filled containers equal to the number of slots provided in the crate, i.e. the crate remains its form when carried by the handles when it is filled with filled containers, and this for a period of at least 10 days at a temperature range between −25° C. and 50° C. and at humidities between 0% and 100%.

The crate or pallet according to the invention is preferably injection molded, either in one single piece or in different pieces that are welded or otherwise joined to one another thereby creating the crate. In its most simple form, the crate side walls, bottom wall and compartment walls are manufactured in a single material.

According to the present invention, a polymer composition comprising a thermoplastic resin and a rubber, wherein said polymer composition does not comprise ethylene vinyl acetate, is used for manufacturing the crate or pallet.

The thermoplastic resin used in the polymer composition is not particularly restricted and may be any of ordinary thermoplastic resins. Preferred resins in accordance with the present invention are: polyolefins, such as polyethylene (PE) and polypropylene (PP); polyesters, such as polyethylene terephthalate (PET), polyethylene terephthalate glycol (PETG); polycarbonates (PC); acrylonitrile-butadiene-styrene (ABS), polymethylmethacrylate (PMMA), polystyrene (PS), polyvinylchloride (PVC), polyamide (PA), polyurethane (PU), melamine, polylactic acid (PLA) and/or combinations thereof. Most preferably, the thermoplastic polymer is a high-density polyethylene (HDPE), a polypropylene (PP) or a blend of HDPE and polyethylene and/or Polypropylene (PP). The thermoplastic resin can be either a virgin resin, a recycled resin or a mixture of virgin and recycled resin.

The rubber in the polymer composition reduces crystallinity of the polymeric crate/pallet and hence brittleness of the crate/pallet and is preferably selected from the group comprising: styrene-based rubbers, such as styrene-butadiene-styrene copolymers and styrene-ethylene-butylene-styrene copolymers; polyolefin based elastomers (POE); nitrile-butadiene rubbers; acrylonitril-butadiene rubbers; chloroprene rubbers; polyisobutylene rubbers and butyl rubber and/or combinations thereof. Preferred rubbers in accordance with the present invention are a styrene-butadiene-styrene copolymer or a rubber made of ethylene propylene diene monomers (EPDM). The amount or rubber in the polymer composition is preferably below 30 w %, more preferably between 5 and 10 w %.

In accordance with the invention, the polymer composition is free of ethylene vinyl acetate (EVA), which is defined as the level of EVA in the polymer composition being below a level wherein the presence of EVA has a measurable effect on the polymer composition in terms of miscibility of the polymer resin and rubber or in terms of the flow characteristics of the polymer composition. Preferably the amount of EVA is below detection level, most preferably no EVA is present in the polymer composition.

In addition to the thermoplastic resin and the rubber, the polymer composition according to the present invention may also comprise a filler material selected from the group comprising: talc, a siloxane, calcium carbonate, carbon black and/or combinations thereof. Talc particles are preferred as a functional filler for increasing stiffness of the polymeric composite and thus strengthening the polymer composite. For talc, the amount present in the polymer composition is preferably less than 40 w % talc, preferably between 5 and 30 w % talc, most preferably between 10 and 25 w % talc. For talc the particle size mean diameter (D50) as dispersed in the polymer composition is preferably between 4 and 8 μm, most preferably about 6 μm, D95 is preferably between 12 and 18 μm, more preferably between 15 and 16 μm.

The polymer composition may further comprise a lubricant, preferably an ultra-high molecular weight siloxane (UHMW-siloxane), eg. Dow Corning MB50-002, the amount of UHMW-siloxane preferably ranging between 0.5 and 5 w % in the polymer composition.

Furthermore, the polymer composition preferably comprises a compatibilizer such as maleic anhydride, more specifically a maleic acid of a grade matching the thermoplastic resin present in the polymer composition. For HDPE based thermoplastic resins, a maleic acid of HDPE grade is preferred, such as for example Exxelor PE1040 commercialized by Exxon Mobil. The amount of maleic acid in the polymer composition preferably ranges between 0.01 and 0.05 w %. The presence of maleic anhydride is particularly desired in combination with the presence of talc.

Other ingredients that may be added to the polymer composition to be used for manufacturing a crate or pallet according to the present invention include: pigments, reinforcing fibers, clay, etc.

All ingredients of the polymer composition are mixed and evenly distributed in the mixture. Alternatively, the thermoplastic material is mixed with a masterbatch comprising the talc and rubber and optional other additives such as compatibilizer, colorant, . . . .

The thermoplastic resin can be either a virgin material or a recycled resin, for example from grinding used crates in accordance with the invention. Such recycled resin can either used as such for making new crates or pallets in accordance with the present invention or can supplemented with a masterbatch comprising talc and rubber to achieve the desired levels thereof in the final composition. Partial replacement of the recycled material with virgin thermoplastic resin is also possible.

Apart from recycling crates or pallets as a whole (in multiple subsequent recycling cycles, wherein used recycled crates or pallets are recycled to produce new crates), the polymer composition according to the present invention can also be used to repair damaged crates or pallets, for example by filling scratches or replacing damaged parts.

Examples of recipes used for the polymeric composition are:

Recipe 1:

### 80 w % HDPE (HDPE Holstalen GC 7260LS-LyondellBasell)

10 w % talc (Talc Imerys Steamic T1CA-Imerys)
5 w % SBS rubber (Styroflex 2G66-Ineos)
3 w % maleic anhydride masterbatch (Exxelor PE1040-Exxon Mobil—the masterbatch comprising 0.79 w % maleic anhydride)
2 w % UHMW siloxane-PE masterbatch (MB50-002-Dow Corning—the masterbatch comprising 50 w % UHMW siloxane)

Recipe 2:

### 65 w % HDPE (HDPE Holstalen GC 7260LS-LyondellBansell)

25 w % talc (Talc Imerys Steamic T1CA-Imerys)
5 w % SBS rubber (Styroflex 2G66-Ineos)
3 w % maleic anhydride masterbatch (Exxelor PE1040-Exxon Mobil—the masterbatch comprising 0.79 w % maleic anhydride)
2 w % UHMW siloxane-PE masterbatch (MB50-002-Dow Corning—the masterbatch comprising 50 w % UHMW siloxane)

In accordance with the present invention, the polymer composition described above is used for manufacturing at least part of a crate, preferably at least the side walls and the bottom wall of the crate, most preferably the side walls, bottom wall and compartment walls of the crate or pallet.

A preferred method of manufacturing these parts of the crate or pallet is by providing the polymer composition and injection molding the crate or crate parts therefrom. This can be achieved in a single injection molding step or in different injection molding steps whereafter the different parts are joined together by welding, overmolding, gluing or any other suitable joining step.

Alternatively, the crate or pallet can be manufactured by extruding a sheet of material from said polymer composition and subsequently thermoforming said sheet of material to obtain said crate or part thereof.

### Examples

From both recipe 1 and recipe 2, a crate was manufactured by injection molding the sidewalls, bottom wall and compartment walls in a single injection molding step.

Both recipe 1 and 2 were used for injection molding plates of 80*80*2 mm3 and of a dumbbell shape (for tensile tests-ASTM D638). The plates and dumbbell shape were submitted to extensive tests including tensile tests (ASTM D638), compression properties tests (ASTM D695), resistance to stress cracking after detergent aging (aging by immersion of the plates in a 2% Teepol solution at 80° C. for 4 hours, visual inspection for cracks, blisters or deformations after aging), resistance to stress cracking under heat (aging by heating the plates for 72 hours at 95° C., visual inspection for cracks, blisters or deformations after aging), density measurements (ASTM D792 (2008) & DIN 53479).

Test samples manufactured from both recipes 1 and 2 were found to meet the requirements for crates.

For the crate recycling different common techniques such as mechanical grinding can be used. The recycled compound can then be injection molded in several subsequent recycling cycles with the crates still meeting the required specifications for use in the market.

1. Use of a polymer composition comprising a thermoplastic resin and a rubber, wherein said polymer composition does not comprise ethylene vinyl acetate, for manufacturing crates or pallets.

2. Use according to claim 1, wherein said crate comprises slots holding beverage bottles or cans, in particular beer bottles or cans.

3. Use according to claim 2 for manufacturing of crates, wherein said thermoplastic resin said thermoplastic resin being a high-density polyethylene (HDPE), or a blend of HDPE with polyethylene and/or polypropylene.

4. A crate comprising an array of slots for holding containers therein or a pallet, said crate or pallet manufactured from a polymer composition comprising a thermoplastic resin and a rubber, characterized in that said polymer composition does not comprise ethylene vinyl acetate.

5. The crate or pallet according to claim 4, said thermoplastic resin being selected from the group comprising polyolefin, polyester, polycarbonate, acrylonitrile-butadiene-styrene (ABS), polymethylmethacrylate (PMMA), polystyrene (PS), polyvinylchloride (PVC), polyamide (PA), polyurethane (PU), melamine, polylactic acid (PLA) and/or combinations thereof.

6. The crate or pallet according to claim 5, said thermoplastic resin being a high-density polyethylene (HDPE), Polypropylene (PP) or a blend of HDPE with polyethylene and/or polypropylene.

7. The crate or pallet according to claim 4, said rubber selected from the group comprising: styrene-based rubber; polyolefin based elastomers (POE); nitrile-butadiene rubbers; acrylonitril-butadiene rubbers; chloroprene rubbers; polyisobutylene rubbers and butyl rubber and/or combinations thereof.

8. The crate or pallet according to claim 7, said rubber being a styrene-butadiene-styrene copolymer or a rubber made of ethylene propylene diene monomers (EPDM).

9. The crate or pallet according to claim 4, said polymer composition comprising less than 30 w % rubber, preferably between 5 and 10 w % rubber.

10. The crate or pallet according to claim 4, said polymer composition comprising a filler material selected from the group comprising: talc, a siloxane, calcium carbonate, carbon black and/or combinations thereof.

11. The crate or pallet according to claim 10, said polymer composition comprising less than 40 w % talc, preferably between 5 and 30 w % talc.

12. The crate or pallet according to claim 4, the polymer composition comprising a lubricant, preferably an ultra-high molecular weight siloxane.

13. The crate or pallet according to claim 4, the polymer composition comprising a compatibilizer, preferably maleic anhydride.

14. The crate or pallet according to claim 13, the polymer composition comprising between 0.01 and 0.05 w % maleic anhydride.

15. Method of manufacturing a crate or pallet according to claim 4, comprising:
providing a polymer composition comprising a thermoplastic resin and a rubber, wherein said polymer composition does not comprise ethylene vinyl acetate, and wherein said thermoplastic resin is a high-density polyethylene (HDPE), or a blend of HDPE with polyethylene and/or polypropylene;
injection molding a crate or pallet with said polymer composition or extruding a sheet of material from said polymer composition and thermoforming said sheet of material to obtain said crate or pallet.
